(19) United States
(12) Patent Application Publication
(10) Pub. No.: US 2005/0285443 A1
(43) Pub. Date: Dec. 29, 2005

(54) System for opening and/or closing a door

(76) Inventor: Jurgen Flach, Eschenburg-Roth (DE)

Correspondence Address: MATHEWS, SHEPHERD, MCKAY, & BRUNEAU, P.A., 100 THANET CIRCLE, SUITE 306, PRINCETON, NJ, 08540, US

(21) Appl. No.: 10/522,501

(22) PCT Filed: Aug. 19, 2003
(86) PCT No.: PCT/EP03/09175

§ 371 Date: Jan. 26, 2005

(30) Foreign Application Priority Data
Aug. 19, 2002 (DE) 102 37 857.6

(51) Int. Cl. B60L 1/00

(52) U.S. Cl. 307/10.1

(57) ABSTRACT

A system and method to open and/or close a garage door enables a receiving unit to activate a door opening and/or closing operator mechanism in response to receiving a signal. The transmitting unit transmits a signal to the receiving unit in response to a pulsed light signal.

### FIELD OF THE INVENTION

This invention relates to remote control devices and more particularly to remote control garage door opener.

### BACKGROUND OF THE INVENTION

Systems to open and/or close a door are very well known. For instance, many garage doors can be opened and closed automatically by using a remote transmitter. In order to prevent unauthorized usage most remote actuators (switches) the user has to use a key or enter a certain code. These systems have more than one disadvantage. One is that the installation efforts are significant because they are hard wired to the operator. To retrofit of these systems are almost impossible.

In order to allow a more convenient activation and to minimize installation systems with transmitting and receiving units are often used. In this case the door is opened and/or closed with help of a remote transmitter. The transmitter is a transmitting unit that when activated sends a coded signal to a receiving unit that is connect to the operator of the door. As soon as this receives the signal it activates the operator of the door to either open or close.

Normally an inferred transmitter is used. For example, the driver of a car who is approaching a door can activate the inferred transmitter, the transmitter will transmit a signal to the receiver that is connected to the door and the door will open automatically.

After passing through the opened door, it can close automatically or after another activation of the inferred transmitter.

These systems have a disadvantage, if such doors in a restricted area should be accessible by many people. Each and every of these individuals have to have an appropriate transmitter. This makes the system expense. In addition, people either forget to carry transmitting units or transmitting units are operational because of week batteries.

Another problem that often occurs is that transmitting units get lost, are stolen, or are not returned by their users. This results in potential unauthorized access. As a result, the transmitting and receiving units have to be reprogrammed or reset or in the worst case replaced.

### SUMMARY OF THE INVENTION

The present invention is a system and method to open and/or close a garage door enables a receiving unit to activate a door opening and/or closing operator mechanism in response to receiving a signal. The transmitting unit transmits a signal to the receiving unit in response to a pulsed light signal.

### BRIEF DESCRIPTION OF THE DRAWINGS

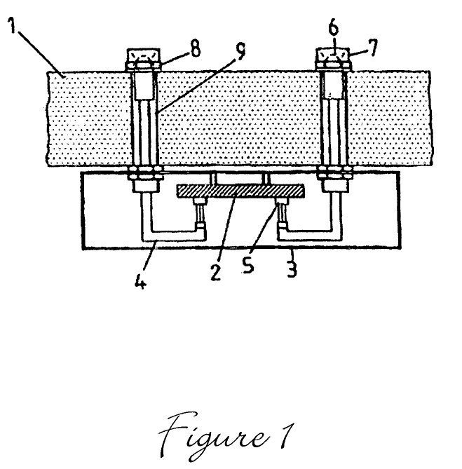

A more complete understanding of the present invention may be obtained from consideration of the following description in conjunction with the drawing in which FIG. 1 is a cross section through the transmitting unit of the present invention.

### DETAILED DESCRIPTION OF VARIOUS ILLUSTRATIVE EMBODIMENTS

Although the present invention, method and system for remote control operation of a door is particularly well suited for use with garage doors and shall be so described, the present invention is equally well suited for use in other remote control environments, including entrance gates, security systems and similar devices.

In order to provide a system to open and/or close a door and with a transmitting unit, to allow a cost efficient use from several users, that is easy to handle and easy to install, that is also easy to retrofit the invention suggests to use a transmitting unit (2) that is activated via light signals.

The present invention is a system or describes a system to open and/or close a door and a transmitting unit. Doors are defined as doors that could close certain areas but also buildings to prevent access of unauthorized persons (doors include barriers, gates, sliding doors, etc.).

It is the objective of the present invention to offer a system to open and/or close a door and its transmitting unit that allows cost efficient usage of multiple users that is easy to handle and easy to install so that retrofit is possible.

This objective is achieved with the present invention by using a system to open and/or close a door and an operator and a transmitting unit and a receiving unit. The transmitting unit is responsible to send the signal to the receiving unit that is attached to the operator of the door and this transmitting unit is activated with light signals.

Because of this idea it is possible to activate the transmitting unit, for example a flashlight or headlights of a car (or other motorized vehicle). The transmitting unit can be installed anywhere near to the door that is to be opened. Thus this door can be activated by a variety of people by just flashing their headlights.

The transmitting unit can be set in way that it can be activated by a coded sequence, for example with 3 short light pulses within a certain time period, such as 2 seconds. Any person who would use this sequence of light pulses (the code) can open the door automatically. In case of a defect, the transmitting needs to be replaced. If the user wants to change to code, the transmitter unit can be modified or reprogrammed. If a formerly authorized person is to be denied entry then the code can simply be changed.

The system is intended to open doors and/or close a door, especially to open a door. A timer can initiate the closing of the door after it has been opened. If in the following just the opening of a door is mentioned the closing of a door is also understood and can be implemented by one skilled in the art with the description provided.

The preferred embodiment the transmitting unit is one that can be activated with the headlights of a car. This has the advantage that you do not need a flashlight or another light source, but just the headlights of a car can be activated in an appropriate manner. Therefore, there is no risk that you lose the flashlight or another appropriate light source and that you just need to maintain just the fixed installed transmitting unit.

In another preferred embodiment, the transmitting unit is attached to the door itself. The advantage is that to activate the transmitting unit, the user drives his car right up to the door and generates the light signals with his car lights. The user can conveniently and without a delay pass through the door.

The transmitting unit sends the signal wireless to the receiving unit. The transmitter has a light sensor and this light sensor senses the light signals and activates it. The light sensor can vary in type and form. It is an advantage to use at least one photo diode.

In one particular embodiment, more than one photo diode is used and they are arranged at different heights to accommodate vehicles with headlights at different heights.

In another preferred embodiment the transmitting unit is configured in a way that only a certain sequence of light signals with a defined length can activate the transmitter. This guarantees that just authorized persons that know the code can open the door.

In another preferred design the transmitting unit contains a device that allows to change the codes (the sequence and length of the light pulses) easily. This allows to withdraw the ability of former authorized persons to open and/or close the door. It means, you just have to change the code (sequence and length of light pulses). Then you have to give authorized persons the new code so they can still operate the door.

In one embodiment jumpers or DIP-switches are used to implement an easily modifiable/programmable code. In yet another embodiment the transmitting unit contains a multi-pole DIP-switch to set the code. The individual code of the transmitting unit with the DIP-switch rules out operating errors of adjacent units.

In yet another embodiment various program versions will be available, the parameters, such as the number of pulses and length of pulses, can be configured in the transmitting unit. Thus allows activation only if the light signals the defined sequence and length.

In yet a further embodiment the transmitting unit has an independent power source preferably a battery. Thus allows operation of the transmitting unit and the light sensor independent from the power supply network. The wiring of power cables are not necessary. Such a system and such a transmitting unit can be retrofit onto doors and door systems without significant modifications.

In another embodiment additional transmitting units are added that can be activated manually without a light signal. This allows persons that frequently and continuously need access to restricted areas to use manual activated transmitters. People that have access temporarily can be given the code that will be changed randomly or periodically to activate the transmitter.

Additional advantages designs and applications of these this invention will become clear by reviewing the following description of one preferred design and its figures.

Referring to FIG. 1 there is shown a cross section through the transmitting unit of the present invention. There can be seen in FIG. 1 the door section 1 attached to this door section is the invented transmitting unit. The transmitting unit of the present invention consists of a transmitting board 2 and is built into a housing 3 and is connected via a connector 5. A connecting wire 4 with photo diode 6. The housing number 3 including the transmitting board 2 is attached from the outside from one side of the door section 1 preferably on the inner side whereas the photo diode 6 in according holders for the diode 7 is mounted on the opposite side preferably the outside of door section 1. The mounting of the unit is realized as follows two tubes 9 have outer threads on both sides those tubes are pushed through a bore in the door section 1. On the outer side a nut 8 is screwed onto the diode holder 7 that holds the photo diode 6. On the other side, the inside of the door, the outer thread of the tube is affixed with two nuts. The outer thread on this side is long enough to go into housing 3 and is here secured with another nut.

Although shown with only two tubes, clearly more than two tubes can be used. By using tubes with an outer thread, it is very easy to install this transmitting unit onto door sections with very different thickness.

The transmitting board 2 can be activated with light pulses which are recognized by the photo diode 6. When a light pulse is detected by photo diode 6, the transmitting unit is activated and sends an according opening signal to the receiving unit (that is not shown), this receiving unit is connected with the drive or the operator of the door to open the door.

Due to the fact that the transmitting unit is attached to the door section 1, the invented transmitting unit and the entire invented system can be retro fit to existing door systems. The code setting, that means the pre-determined sequence and length of light pulses can be changed with a code setting unit which can consist for example of out of jumpers or DIP switches. Alternatively, the code can be changed via software to change the code. The power supply of the transmitting unit is realized preferably without a connection to a power network in order to avoid the necessity to hard wire power supply cables to the unit.

Preferably the electronic of the transmitting unit is capable of differentiating between the increasing amount of light caused by a car light or caused by reflections and shade that people or other objects generate, these can occur when the sun transmits light onto the photo diode and someone or something is moving and therefore is a change of light that reaches the light diodes. An unintended opening of the door caused by moving persons or objects can therefore be avoided.

A preferred embodiment has two LED's to show the function of the unit. The first LED shows if an increase of light intensity occurred on photo diode 6, and the second LED will light up as soon as the transmitter is activated. It is possible to add a third LED that will go on when the light intensity decreases.

An FM transmitting signal with a frequency of 40.685 megahertz to the receiving unit and this causes an opening of the door operator.

In the design that is shown, the transmitting housing and the photo diodes including the holders for the photo diodes are one unit. To mount the housing 3, the two tubes 9 are tightened within the housing 3 by using two nuts 8. Transmitting board 2 is in the housing 3. The other end of tube 9 which are pushed through the door section 1 will be secured with two nuts 8. The photo diode 6 can be pushed in from the outside into tube 9 and will be connected to transmitting board 2 within the housing 3.

In one preferred design the tubes 9 are already mounted when the door panel is delivered. In addition to the two photo diodes, a third tube with photo diodes can be mounted in between. The transmitting board has one available additional input for a fourth photo diode which can be integrated into the door section (this is even possible without using a tube). In order to do so, there has to be 2 additional bores in the door section, the transmitter with the tubes will be inserted and tightened with nuts 8. Finally, the user specific code has to be set and the receiving unit has to teach in these code (by pushing one button). As the standard, it is a preferred design to use two photo diodes 6 that are already installed and connected. If a third or a fourth diode 6 is necessary, those can be added to the system very easily. If necessary, a special optic can be used to optimize the characteristics if the sun is in a very low position.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications, which come within the scope of the appended claim, is reserved.

1-11. (canceled)

12. An external interface to automatically open and or close a door in response to a pulsed light signal having a predetermined characteristic, a motor coupled to the door for moving the door between an open position and a closed position covering an opening, a controller controlling operation of the motor in response to received command signals, the external interface comprising:
a transmitting unit for generating and transmitting command signals to move the door to the open position;
at least one detector for detecting the pulsed light signal;
a detector interface, for stimulating said transmitting unit to generate and transmit command signals to move the door to the open position, in response to the pulsed light signal;
a programmable interface coupled to said detector interface wherein the predetermined characteristic of the pulsed light signal for said detector interface can be programmed;
wherein when said detector detects the pulsed light signal having the predetermined characteristic said detector interface stimulates said transmitting unit to generate and transmit said command signals to move the door to the open position.

13. The external interface as recited in claim 12 wherein said transmitting unit further comprises a wireless transmitter for transmitting said command signals.

14. The external interface as recited in claim 12 wherein said detector interface is responsive to a predetermined sequence of the pulsed light signal.

15. The external interface as recited in claim 12 wherein said detector interface is responsive to a predetermined duration of the pulsed light signal.

16. The external interface as recited in claim 12 wherein said detector interface is responsive to a predetermined sequence and a predetermined duration of the pulsed light signal.

17. The external interface as recited in claim 12 wherein said programmable interface further comprises jumpers for programming the predetermined characteristic of the pulsed light signal.

18. The external interface as recited in claim 12 wherein said programmable interface further comprises DIP switches for programming the predetermined characteristic of the pulsed light signal.

19. The external interface as recited in claim 12 wherein said programmable interface further comprises digital means for programming the predetermined characteristic of the pulsed light signal.

20. The external interface as recited in claim 12 further comprising an independent battery power source.

21. The external interface as recited in claim 12 wherein said transmitting unit generates and transmits a coded signal.

22. The external interface as recited in claim 12 wherein said detector interface is responsive as a function of time.

23. The external interface as recited in claim 12 wherein said at least one detector is a plurality of detectors.

24. The external interface as recited in claim 19 wherein said programmable interface further means to learn the predetermined characteristic of the pulsed light signal when said programmable interface is in a learn mode.

25. An system to automatically open and or close a door in response to a pulsed light signal having a predetermined characteristic, a motor coupled to the door for moving the door between an open position and a closed position covering an opening, a controller controlling operation of the motor in response to received command signals, the external interface comprising:
a transmitting unit for generating and transmitting command signals to move the door to the open position;
at least one detector for detecting the pulsed light signal;
a detector interface, for stimulating said transmitting unit to generate and transmit command signals to move the door to the open position, in response to the pulsed light signal;
a programmable interface coupled to said detector interface wherein the predetermined characteristic of the pulsed light signal for said detector interface can be programmed;
wherein when said detector detects the pulsed light signal having the predetermined characteristic said detector interface stimulates said transmitting unit to generate and transmit said command signals to move the door to the open position.

26. The system as recited in claim 25 wherein said transmitting unit further comprises a wireless transmitter for transmitting said command signals, said transmitting united mounted on the door.

27. The system as recited in claim 25 wherein said detector interface is responsive to a predetermined sequence of the pulsed light signal.

26. The system as recited in claim 25 wherein said detector interface is responsive to a predetermined duration of the pulsed light signal.

28. The system as recited in claim 25 wherein said programmable interface further comprises digital means for programming the predetermined characteristic of the pulsed light signal.

29. The system as recited in claim 25 wherein said detector interface is responsive as a function of time.

30. The system as recited in claim 25 wherein said at least one detector is a plurality of detectors.

31. The system as recited in claim 28 wherein said programmable interface further means to learn the predetermined characteristic of the pulsed light signal when said programmable interface is in a learn mode.
